(19) United States
(12) Patent Application Publication
(10) Pub. No.: US 2009/0028036 A1
(43) Pub. Date: Jan. 29, 2009

(54) OPTICAL DISC DEVICE

(75) Inventors: Seiji Nishiwaki, Hyogo (JP); Kazuo Momoo, Osaka (JP); Junichi Asada, Hyogo (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi, Osaka (JP)

(21) Appl. No.: 12/282,598

(22) PCT Filed: Mar. 13, 2007
(86) PCT No.: PCT/JP2007/054883

§ 371 Date: Sep. 11, 2008

(30) Foreign Application Priority Data
Mar. 14, 2006 (JP) 2006-068777

(51) Int. Cl. G11B 7/135

(52) U.S. Cl. 369/112.23

(57) ABSTRACT

The invention permits stable tracking with few control errors, uninfluenced by stray light reflected by signal surfaces other than the signal surface being used for focusing during recording and playback of a multilayer disc. To this end, the optical splitter element of the optical disc device according to the present invention has first areas (21c-24c), which include the location (20) of the optical axis of light incident from the objective lens, and, around the periphery of the first areas, second areas (21a-24a, 21b-24b) positioned at locations displaced from the optical axis. The detection surface (9a) of the photodetector has first detection areas (97, 98) detecting light incident from the first areas and second detection areas (95, 96) detecting light incident from the second areas. The second detection areas are used for detecting tracking error signals. If the optical disc has multiple signal surfaces, light that is reflected by signal surfaces other than the signal surface being used for focusing and is incident on the photodetector from the first areas is not incident on the second detection areas.

### TECHNICAL FIELD

The present invention relates to an optical disc device used for recording signals on an optical disc or for playing back signals recorded on an optical disc.

### BACKGROUND ART

In conventional technology, an optical disc device has been disclosed, for instance, in JP 2000-132848A (Patent Document 1). This precedent, partly modified, will be used here to provide explanations with reference to FIG. 1, FIG. 7, and FIG. 8.

FIG. 1A illustrates, in cross-section, the configuration of the main portion of a conventional optical disc device. As illustrated in FIG. 1A, the conventional optical disc device includes a photodetecting substrate 9 and a light source 1 attached to the photodetecting substrate 9. The light source 1 is, for instance, a semiconductor laser, etc. Moreover, in the optical path of laser light 1a emitted from the light source 1, the optical disc device includes a collimating lens 4, a polarizing holographic substrate 2, a quarter wave plate 3, and an objective lens 5. The quarter wave plate 3 is provided on the rear face of the polarizing holographic substrate 2.

FIG. 1B is a cross-sectional view illustrating the configuration of the photodetecting substrate 9 of FIG. 1A intersected with a plane that includes the optical path of the laser light 1a and is perpendicular to the cross-section of FIG. 1A. As illustrated in FIG. 1B, a reflective mirror 10, which has a reflective surface inclined by about 45 degrees to the surface of the substrate surface, is provided on the photodetecting substrate 9. The laser light 1a emitted from the light source 1 towards the reflective surface of the reflective mirror 10 is reflected by the reflective surface, moves towards the collimating lens 4, and is converted to collimated light by the collimating lens 4. Furthermore, the collimated light emitted from the collimating lens 4 is transmitted through the polarizing holographic substrate 2, converted from linearly polarized light (S-waves or P-waves) into circularly polarized light by the quarter wave plate 3, and collected and focused onto a signal surface 6a of an optical disc 6 by the objective lens 5. Light reflected by the signal surface 6a passes through the objective lens 5 and is converted into linearly polarized light (P-waves or S-waves) by the quarter wave plate 3. This linearly polarized light is incident on a holographic surface 2a on the polarizing holographic substrate 2 and is diffracted and split into 1st order diffracted light 8 and −1st order diffracted light 8′, for which the optical axis 7 serves as the axis of symmetry. These diffracted light components pass through the collimating lens 4, turn into converging light, and are incident upon the detection surface 9a of the photodetecting substrate 9. It should be noted that the quarter wave plate 3 is adhesively attached to the polarizing holographic substrate 2, with both provided in the same enclosure as the objective lens 5 and moving as a single unit. The detection surface 9a is positioned substantially at the location of the focal plane of the collimating lens 4 (i.e. the location of the virtual emission point of the light source 1).

FIG. 7A and FIG. 7B illustrate the configuration of the holographic surface 2a and detection surface 9a of a conventional optical disc device. FIG. 7A, which is a plan view of the detection surface 9a as viewed from the side of the optical disc 6, also illustrates optical spots formed on the detection surface 9a. FIG. 7B is a plan view of the holographic surface 2a as viewed from the side of the optical disc 6.

In FIG. 7B, two straight lines (X-axis, Y-axis), which intersect at right angles at an intersection point 20 between the holographic surface 2a and optical axis 7, divide the holographic surface 2a into four quadrants, i.e. a first quadrant 21, a second quadrant 22, a third quadrant 23, and a fourth quadrant 24. The Y-axis is parallel to a radial direction of the optical disc 6 and diffracted light components 80a, 80b, which are produced by guide grooves formed on the signal surface 6a of the optical disc 6, shift in the direction of the Y-axis and overlap with the returned light 80 on the holographic surface 2a. It should be noted that the outline of the optical spot in FIG. 7B is shown by a dashed line. The passage of this light through the holographic surface 2a produces ±1st order diffracted light components, with each diffracted light component respectively divided into four parts and projected onto the detection surface 9a.

As illustrated in FIG. 7A, two straight lines, which intersect at right angles at a point of intersection 90 between the detection surface 9a and optical axis 7 and are parallel to the X-axis and Y-axis, are used as an x-axis and a y-axis on the detection surface 9a and trapezoidal tracking detection cells 91, 92, 93, 94 are arranged on the “+” side of the y-axis. Moreover, focus detection cells 95 and 96, which form a comb-shaped configuration parallel to the y-axis, are arranged in an alternating fashion on the “−” side of the y-axis. In FIG. 7A, identical reference numerals are given to electrically communicating detection cells and all subsequent descriptions of the present specification are based on the same approach. The external configuration of these detection cells is substantially symmetrical with respect to the y-axis. It should be noted that the light 1a emitted from the emission point of the light source 1 travels parallel to the x-axis in a plane parallel to the paper surface in FIG. 7 and is reflected by the reflective mirror 10 in the direction of the optical axis (the direction extending through the point 90 at right angles to the surface of the paper).

In FIG. 7A and FIG. 7B, the 1st order diffracted light diffracted in the first quadrant 21 of the holographic surface 2a is focused into an optical spot 81S, which is contained within the detection cell 91, and the −1st order diffracted light is focused into an optical spot 81S′, which spans a boundary between a detection cell 95 and a detection cell 96. The 1st order diffracted light diffracted in the second quadrant 22 is focused into an optical spot 82S, which is contained within the detection cell 92, and the −1st order diffracted light is focused into an optical spot 82S′, which spans a boundary between a detection cell 95 and a detection cell 96. The 1st order diffracted light diffracted in the third quadrant 23 is focused into an optical spot 83S, which is contained within the detection cell 93, and the −1st order diffracted light is focused into an optical spot 83S′, which spans a boundary between a detection cell 95 and a detection cell 96. The 1st order diffracted light diffracted in the fourth quadrant 24 is focused into an optical spot 84S, which is contained within the detection cell 94, and the −1st order diffracted light is focused into an optical spot 84S′, which spans a boundary between a detection cell 95 and a detection cell 96. It should be noted that while the y-direction focal lines in the focal spots may be on either side of the detection surface 9a, the x-direction focal lines are behind the detection surface 9a as viewed from the side of the holographic surface 2a in case of the 1st order diffracted light and are in front of the detection surface 9a as viewed from the side of the holographic surface 2a in case of the −1st order diffracted light. In FIG. 7A, the y-direction focal lines have been made to coincide with the location of the x-direction focal lines (so-called stigmatic focus).

It should be noted that, in the device described in the above-mentioned JP 2000-132848A, each quadrant of the holographic surface is further subdivided into strip-like configurations parallel to the X-axis, with light transmitted through every other strip-shaped area focused behind the detection surface 9a and light transmitted through every other strip-like area located therebetween focused in front of the detection surface 9a (in case of 1st order diffracted light) so as to span the boundary lines between identical detection cells 95 and detection cells 96. However, since the issue of whether the holographic surface is divided into strip-like areas or not is irrelevant to the features of the instant invention, for simplicity, the following explanations will refer to an embodiment without strip-like areas. It should be noted that while explanations in the hereinafter described embodiments will be provided in a similar manner, i.e. based on the assumption that the holographic surface is not divided into strip-like areas, embodiments in which the holographic surface is divided into strip-like areas also fall within the technical scope of the present invention.

In the configuration illustrated in FIG. 7A and FIG. 7B, the following six signals are obtained by the detection cells 95, 96.

T1 is a signal obtained in the detection cell 91, T2 is a signal obtained in the detection cell 92, T3 is a signal obtained in the detection cell 93, T4 is a signal obtained in the detection cell 94, F1 is a signal obtained in the detection cell 95, and F2 is a signal obtained in the detection cell 96.

A tracking error signal TE relating to the tracks of the optical disc 6, a focus error signal FE relating to the signal surface 6a of the optical disc 6, and a playback signal RF relating to the signal surface 6a of the optical disc 6 are obtained from these detected signals based on the following expressions (1)-(3).

TE=T1+T2−T3−T4 (1)

FE=F1−F2 (2)

RF=F1+F2+T1+T2+T3+T4 (3)

### DISCLOSURE OF INVENTION

### Problem to be Solved by the Invention

Such conventional optical disc devices suffered from the following problems.

FIG. 8A and FIG. 8B illustrate the appearance of optical spots on the detection surface 9a obtained in a conventional example when a focused light beam is defocused relative to the signal surface 6a of the optical disc 6. FIG. 8A is a diagram illustrating a situation in which the signal surface 6a is closer to the objective lens 5 than under focused conditions, and FIG. 8B is a diagram illustrating a situation in which the signal surface 6a is farther from the objective lens 5 than under focused conditions. It should be noted that while only the optical spots of the 1st order diffracted light formed in the “+” direction of the y-axis on the detection surface 9a are depicted in FIG. 8A and FIG. 8B, the configuration of the optical spots of the −1st order diffraction light is substantially point-symmetrical to the optical spots of the 1st order diffracted light about the point of origin 90 illustrated in FIG. 7A. In FIG. 8A, portions of the optical spots 81S, 83S, and 84S respectively encroach upon the detection cells 92, 94, and 91. In FIG. 8B, portions of the optical spots 81S, 82S, and 84S respectively encroach upon the detection cells 94, 91, and 93. In case of the so-called dual-layer discs, which have been commercialized as DVD-Rs, Blu-Ray discs etc. and have a two-layer structure with two signal surfaces sandwiching an adhesive layer, light reflected by other signal surfaces in the process of focusing on one of the signal surfaces returns, after a round trip, to the detection surface 9a in a state wherein it is defocused by 2d/n, where “d” is the thickness of the adhesive layer and “n” is the index of refraction. Accordingly, as illustrated in FIG. 8A and FIG. 8B, light reflected by a signal surface other than the signal surface being used for recording and playback converts into stray light and enters the tracking error detector, thereby preventing normal tracking control and causing off-track errors and track jumps.

Taking account of such problems, it is an object of the present invention to provide an optical disc device permitting stable tracking with few control errors, uninfluenced by stray light reflected by signal surfaces other than the signal surface being used for focusing during recording and playback of multi-layer discs.

### Means for Solving Problem

In order to attain the above-mentioned object, the optical disc device of the present invention is an optical disc device including a light source, an optical splitter element, an objective lens, and a photodetector, wherein the objective lens, along with focusing light emitted from the light source onto a signal surface of an optical disc, allows light reflected by the signal surface to be incident on the photodetector; the optical splitter element has first areas including the location of the optical axis of light incident from the objective lens and, around the periphery of the first areas, second areas positioned at locations displaced from the optical axis, separates light incident on the first areas from light incident on the second areas and allows it to be incident on the photodetector. The detection surface of the photodetector has first detection areas used for detecting light incident from the first areas of the optical splitter element and second detection areas provided at locations displaced from the first detection areas and used for detecting light incident from the second areas of the optical splitter element, with signals detected in the second detection areas used for detecting tracking error signals of the optical disc. When the optical disc has multiple signal surfaces, the portion of the light reflected by signal surfaces other than the signal surface being used for focusing by the objective lens that is composed of light incident on the photodetector from the first areas of the optical splitter element is not incident on the second detection areas.

As a result of using this configuration, when recording and playback is carried out using a so-called multi-layer disc having multiple signal surfaces, tracking error signals can be detected with accuracy because light reflected from signal surfaces other than the signal surface being used for recording and playback is not incident on the second detection areas used for detecting tracking error signals. As a result, an optical disc device can be provided that permits stable tracking with few control errors, uninfluenced by stray light reflected by signal surfaces other than the signal surface being used for focusing.

In the above-mentioned optical disc device, it is preferable for the photodetector to detect focus error signals of the optical disc using signals detected in the first detection areas.

Moreover, in the above-mentioned optical disc device, the optical splitter element preferably is formed such that the portion of the light reflected by other signal surfaces that is constituted by light incident on the photodetector from the first areas of the optical splitter element, is not incident on the second detection areas when “d” (wherein “d” represents the distance between the signal surface of the optical disc used for focusing by the objective lens and another signal surface) is in the range of from 40 μm to 70 μm (more preferably, when “d” is 55 μm). This makes it possible to protect DVD-Rs, in which the gap between the signal surfaces is set to be in the range of from 40 μm to 70 μm, from being affected by stray light reflected by signal surfaces other the signal surface used for focusing during recording and playback and permits stable tracking with few control errors.

Moreover, in the above-mentioned optical disc device, the optical splitter element preferably is formed such that the portion of the light reflected by other signal surfaces that is composed of light incident on the photodetector from the first areas of the optical splitter element is not incident on the second detection areas when “d” (wherein “d” represents the distance between the signal surface of the optical disc used for focusing by the objective lens and another signal surface) is in the range of from 20 μm to 30 μm (more preferably, when “d” is 25 μm). This makes it possible to protect Blu-Ray discs, in which the gap between the signal surfaces is set to be in the range of from 20 μm to 30 μm, from being affected by stray light reflected by signal surfaces other than the signal surface being used for focusing during recording and playback and permits stable tracking with few control errors.

Moreover, in the above-mentioned optical disc device, the optical splitter element preferably is formed such that the portion of the light reflected by other signal surfaces that is composed of light incident on the photodetector from the first areas of the optical splitter element is not incident on the second detection areas when “d” (wherein “d” represents the distance between the signal surface of the optical disc used for focusing by the objective lens and another signal surface) is in the range of from 17 μm to 23 μm (more preferably, when “d” is 20 μm). This makes it possible to protect HD-DVDs, in which the gap between the signal surfaces is set to be in the range of from 17 μm to 23 μm, from being affected by stray light reflected by signal surfaces other than the signal surface being used for focusing during recording and playback and permits stable tracking with few control errors.

Moreover, if the location of the optical axis of light incident on the surface of the photodetector without being split by the optical splitter element is used as the point of origin, a straight line that passes through the point of origin and is parallel to a radial direction of the optical disc is used as a y-axis, and a straight line that passes through the point of origin and intersects at right angles with the y-axis is used as an x-axis, the above-mentioned optical disc device may utilize an embodiment, wherein the second detection areas in the photodetector are formed parallel to the y-axis and the first detection areas are formed such that they are split in two in the direction of the x-axis so as to sandwich the second detection areas.

Alternatively, if the location of the optical axis of light incident on the surface of the photodetector without being split by the optical splitter element is used as the point of origin, a straight line that passes through the point of origin and is parallel to a radial direction of the optical disc is used as a y-axis, and a straight line that passes through the point of origin and intersects at right angles with the y-axis is used as an x-axis, the above-mentioned optical disc device may utilize an embodiment, wherein the first detection areas in the photodetector are formed parallel to the y-axis and the second detection areas are formed by splitting them in two in the direction of the x-axis so as to sandwich the first detection areas.

Moreover, in the above-mentioned optical disc device, the second detection areas preferably have a first portion, whose length in the direction of the x-axis is relatively smaller, and a second portion, whose length is relatively larger. Furthermore, if we designate the length of the first portion in the direction of the x-axis in the second detection areas as w1 and the length of the second portion in the direction of the x-axis as w2, then, among the optical spots formed in the second detection areas at zero defocus with respect to the signal surface of the optical disc, those optical spots that are located in the second portion are formed substantially in the center of the second portion in the direction of the y-axis, at locations spaced away by w1/2 from the y-axis.

### EFFECTS OF THE INVENTION

The invention above prevents light reflected by surfaces other than the signal surface being used for recording and playback from entering the photodetector as stray light during recording and playback of dual layer discs and multi-layer discs. Accordingly, highly accurate tracking error signals can be obtained from the optical signals detected by the photodetector, thereby enabling stable tracking control with few errors. This allows for cancelling off-track errors during tracking control even if the objective lens exhibits eccentricity in the radial direction of the disc.

### BRIEF DESCRIPTION OF DRAWINGS

FIG. 1 is a cross-sectional view of the configuration of an embodiment of the present invention, as well as a conventional optical disc device.

FIG. 2A and FIG. 2B are diagrams illustrating the configuration of the holographic surface and detection surface of an optical disc device according to an embodiment of the present invention, along with the arrangement of the optical spots formed on these surfaces.

FIG. 3A and FIG. 3B are explanatory diagrams illustrating optical spots obtained on the detection surface under defocus conditions in an optical disc device according to an embodiment of the present invention.

FIG. 4A and FIG. 4B are diagrams used to explain the conditions required for preventing light reflected from signal surfaces other than the signal surface being used for recording and playback from striking the detection surface when recording and playback is carried out on a multi-layer disc in an optical disc device according to an embodiment of the present invention.

FIG. 5 is a diagram illustrating the arrangement of the optical spots and the configuration of the detection surface of an optical disc device according to another embodiment of the present invention.

FIG. 6A and FIG. 6B are explanatory diagrams illustrating optical spots obtained on the detection surface under defocus conditions in an optical disc device used in another embodiment of the present invention illustrated in FIG. 5.

FIG. 7A and FIG. 7B are diagrams illustrating the configuration of the holographic surface and detection surface in a conventional optical disc device, along with the arrangement of the optical spots formed on these surfaces.

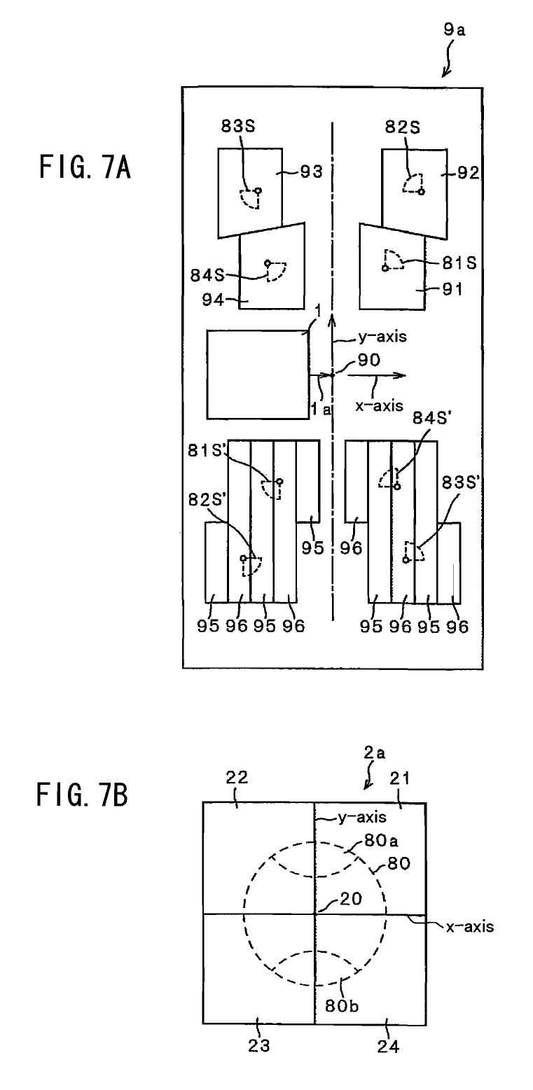

FIG. 8A and FIG. 8B are explanatory diagrams of optical spots obtained on the detection surface under defocus conditions in a conventional optical disc device.

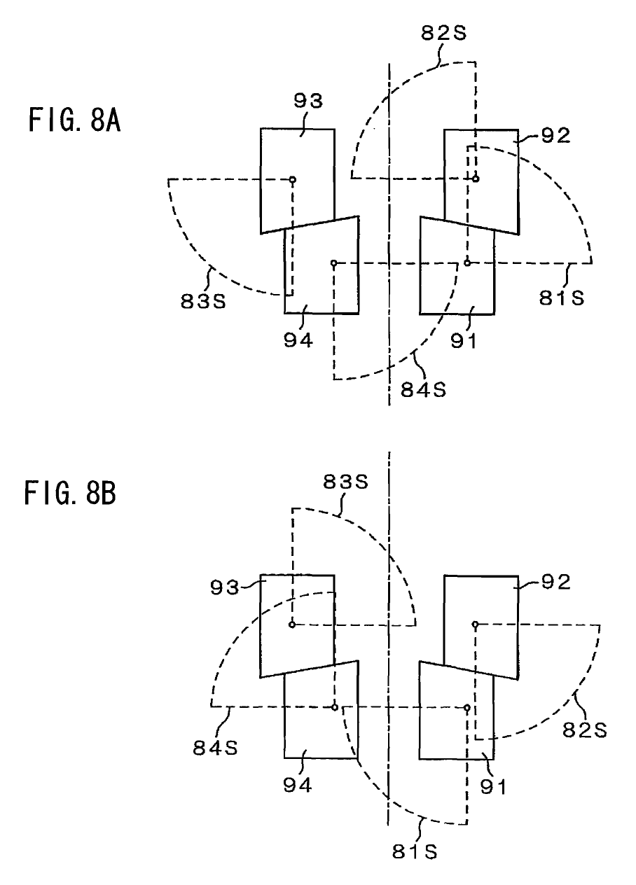

### BEST MODE FOR CARRYING OUT THE INVENTION

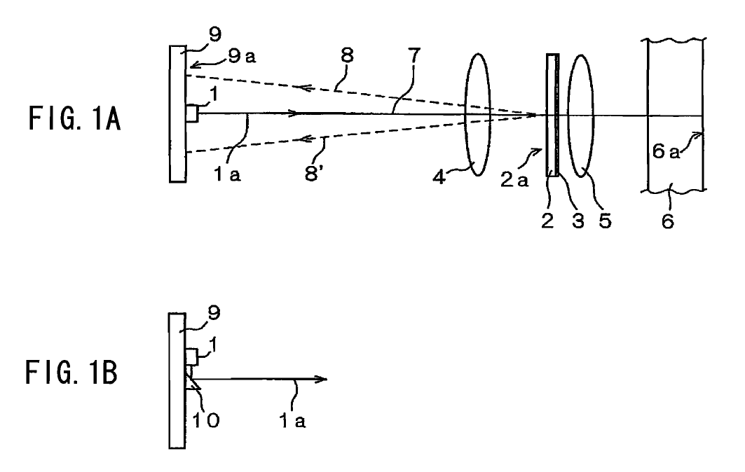

Below, an optical disc device according to an embodiment of the present invention will be explained in detail with reference to FIG. 1-FIG. 6. It should be noted that components common to the previously described conventional optical disc device are given identical reference numerals.

In the same manner as the conventional optical disc device illustrated in FIG. 1, the optical disc device of the present embodiment includes a photodetecting substrate 9 and a light source 1 attached to the photodetecting substrate 9. The light source 1 is, for instance, a semiconductor laser, etc. Moreover, in the same manner as the conventional optical disc device, in the optical path of laser light 1a emitted from the light source 1, this optical disc device includes a collimating lens 4, a polarizing holographic substrate 2, a quarter wave plate 3, and an objective lens 5. The quarter wave plate 3 is provided on the rear face of the polarizing holographic substrate 2. However, the optical disc device according to the present embodiment differs from the conventional optical disc device in the area configuration of the holographic surface 2a of the polarizing holographic substrate 2 and in the arrangement of the detection cells on the detection surface 9a of the photodetecting substrate 9.

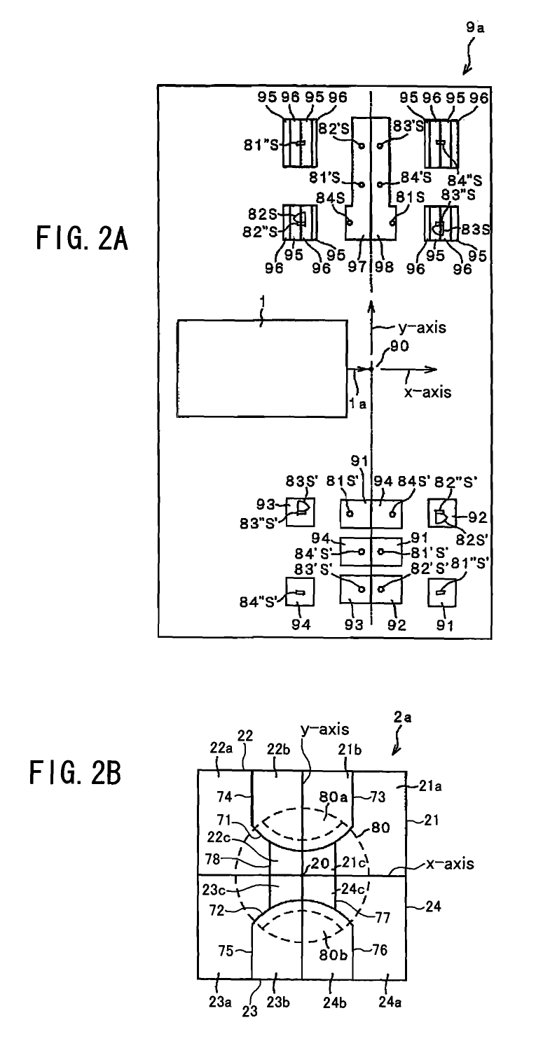

FIG. 2A and FIG. 2B illustrate the configuration of the holographic surface 2a and detection surface 9a of the optical disc device according to the present embodiment. FIG. 2A is a plan view of the detection surface 9a as viewed from the side of the optical disc 6. FIG. 2B is a plan view of the holographic surface 2a as viewed from the side of the optical disc 6.

In the optical disc device according to the present embodiment, the holographic surface 2a of the polarizing holographic substrate 2 is divided into four quadrants 21, 22, 23, and 24 by two straight lines (X-axis, Y-axis) intersecting at right angles at a point of origin 20, which is the point of intersection between the holographic surface 2a and optical axis 7. The quadrants 21-24 are divided into three areas by two arcs 71 and 72 linearly symmetrical with respect to the X-axis, line segments 73, 74, 75, and 76 extending from the ends of the arcs 71 and 72 parallel to the Y-axis and away from the X-axis, and line segments 77 and 78 perpendicularly intersecting with the X-axis and having both ends thereof intersecting with the arcs 71 and 72.

As a result, the first quadrant 21 is divided into areas 21a, 21b, and 21c. The second quadrant 22 is divided into areas 22a, 22b, and 22c. The third quadrant 23 is divided into areas 23a, 23b, and 23c. The fourth quadrant 24 is divided into areas 24a, 24b, and 24c. The areas 21c, 22c, 23c, and 24c are adjacent to the point of origin 20. The areas 21a, 22a, 23a, and 24a are areas displaced from the point of origin 20 in the direction of the X-axis. In other words, these are areas adjacent to the areas 21c, 22c, 23c, and 24c in the direction of the X-axis. The areas 21b, 22b, 23b, and 24b are areas displaced from the point of origin 20 in the direction of the Y-axis. In other words, these are areas adjacent to the areas 21c, 22c, 23c, and 24c in the direction of the Y-axis.

The Y-axis is parallel to a radial direction of the optical disc 6, and diffracted light 80a, 80b, which is produced by guide grooves formed on the signal surface 6a of the optical disc 6, moves in the direction of the Y-axis and overlaps with the returned light 80 on the holographic surface 2a. In FIG. 2A, the outline of the light returned from the optical disc 6 is shown with a dashed line, with the optical disc 6 having a narrow pitch format, such as DVD-R or DVD-RW, etc. As a result of passing through the holographic surface 2a, this light produces ±1st order diffracted light. The diffracted light components are divided into the three areas provided in each of the respective four quadrants, as a result of which they are divided into 12 light components and projected onto the detection surface 9a of the photodetecting substrate 9. In other words, the areas 21a-21c in the first quadrant 21 have mutually different holographic patterns (grating patterns). As a result, light transmitted through the areas 21a-21c travels in three mutually different directions and is projected onto three mutually different locations on the detection surface 9a. The same applies to the areas 22a-22c in the second quadrant 22, to the areas 23a-23c in the third quadrant 23, and to the areas 24a-24c in the fourth quadrant 24.

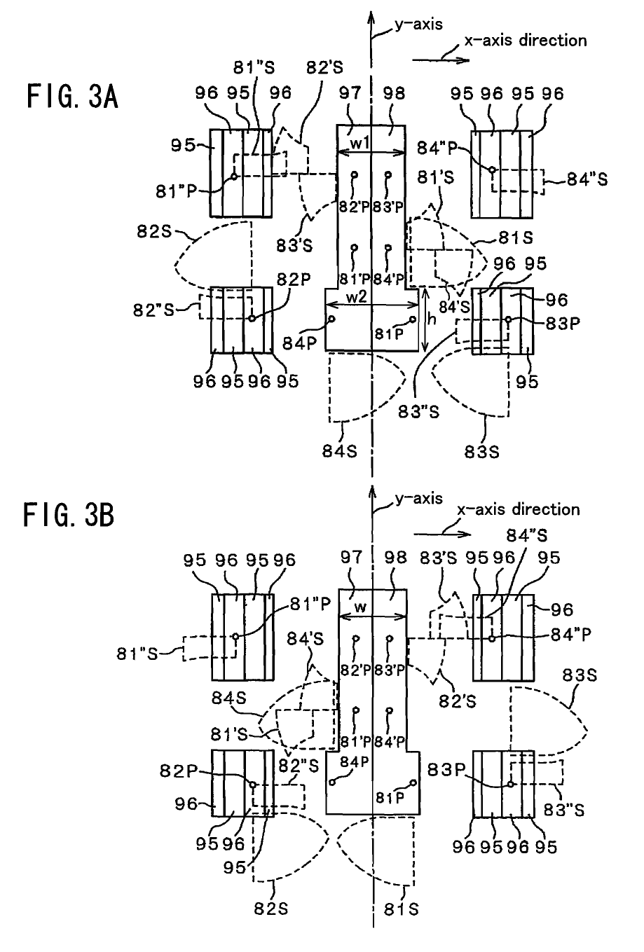

On the other hand, as illustrated in FIG. 2A, when two straight lines parallel to the X-axis and Y-axis, which intersect at right angles at the point of origin 90, which is the point of intersection between the detection surface 9a and optical axis 7, are used as an x-axis and y-axis, focus detection cells 95 and 96, which form a comb-like configuration, are arranged in an alternating fashion parallel to the y-axis, on the “+” side of the y-axis on the detection surface 9a of the photodetecting substrate 9. In FIG. 2A, the same reference numerals are given to electrically communicating detection cells. Moreover, tracking detection cells 97, 98 are arranged in the vicinity of the y-axis. The configuration of the tracking detection cells 97, 98 is symmetrical with respect to the y-axis, with the y-axis serving as a boundary line therebetween. In the tracking cells 97 and 98, the area corresponding to the “−” side of the y-axis protrudes in the “−” or “+” direction of the x-axis relative to other areas. As illustrated in FIG. 3A, the width of the tracking detection cells 97, 98 in the direction of the x-axis is w2/2 in the area that has a height of h from the end facing the “−” direction of the y-axis and w1/2 in the area located farther in the “+” direction of the y-axis than said area. It should be noted that w2>w1.

The focus detection cells 95, 96 are arranged at locations displaced from the tracking detection cells 97 and 98 so as to sandwich the tracking detection cells 97, 98 therebetween, with their external configurations being substantially symmetrical about the y-axis. The square tracking detection cells 91, 92, 93, and 94 are arranged in a distributed fashion on the “−” side of the y-axis. It should be noted that electrically communicating detection cells among the detection cells 91, 92, 93, and 94 are also given identical reference numerals. In addition, light 1a emitted from the emission point of the light source 1 travels parallel to the x-axis in a plane parallel to the paper surface in FIG. 2 and is reflected by the reflective mirror 10 in the direction of the optical axis (the direction extending through the point of origin 90 at right angles to the surface of the paper).

The 1st order diffracted light diffracted through the area 21a of the holographic surface 2a is focused into the optical spot 81S contained within the tracking detection cell 98 and the −1st order diffracted light is focused into the optical spot 81S′ contained within the detection cell 91. It should be noted that the optical spot 81S and optical spot 81S′ are positioned at locations symmetrical about the point of origin 90. Furthermore, the 1st order diffracted light diffracted through the area 21b is focused into the optical spot 81′S contained within the tracking detection cell 97 and the −1st order diffracted light is focused into the optical spot 81′S′ contained within the detection cell 91. The optical spot 81′S and optical spot 81′S′ are positioned at locations symmetrical about the point of origin 90. The 1st order diffracted light diffracted through the area 21c is focused into the optical spot 81″S spanning a boundary between focus detection cells 95 and 96, and the −1st order diffracted light is focused into the optical spot 81″S′ contained within the detection cell 91.

The optical spot 81″S and optical spot 81″S′ are positioned at locations symmetrical about the point of origin 90.

In a similar manner, the 1st order diffracted light diffracted through the areas 22a and 22c is focused into the optical spots 82S, 82″S spanning a boundary between focus detection cells 95 and 96, and the −1st order diffracted light is focused into the optical spot 82S′, 82″S′ contained within the detection cell 92. The 1st order diffracted light diffracted through the area 22b is focused into the optical spot 82′S contained within the tracking detection cell 97 and the −1st order diffracted light is focused into the optical spot 82′S′ contained within the detection cell 92.

Moreover, the 1st order diffracted light diffracted through the areas 23a and 23c is focused into the optical spots 83S, 83″S spanning a boundary between focus detection cells 95 and 96, and the −1st order diffracted light is focused into the optical spots 83S′, 83″S′ contained within the detection cell 93. The 1st order diffracted light diffracted through the area 23b is focused into the optical spot 83′S contained within the tracking detection cell 98 and the −1st order diffracted light is focused into the optical spot 83′S′ contained within the detection cell 93.

Moreover, the 1st order diffracted light diffracted through the area 24a is focused into the optical spot 84S contained within the tracking detection cell 97 and the −1st order diffracted light is focused into the optical spot 84S′ contained within the detection cell 94. The 1st order diffracted light diffracted through the area 24b is focused into the optical spot 84′S contained within the tracking detection cell 98 and the −1st order diffracted light is respectively focused into the optical spot 84′S′ contained within the detection cell 94. The 1st order diffracted light diffracted through the area 24c is focused into the optical spot 84′S spanning a boundary between focus detection cells 95 and 96 and the −1st order diffracted light is focused into the optical spot 84′S′ contained within the detection cell 94.

It should be noted that the focal spots 81S, 84S, 81′S, 82′S, 83′S, and 84′S, which are formed by the 1st order diffracted light, consist of light focused substantially on the detection surface 9a. The focal lines of the focal spots 81″S, 82S, 82″S, 83S, 83″S, and 84″S in the direction of the y-axis may be on either side of the detection surface 9a, but the focal lines in the direction of the x-axis are located behind the detection surface 9a as viewed from the side of the holographic surface 2a. In FIG. 2A, the y-direction focal lines are made to coincide with the location of the x-direction focal lines (so-called stigmatic focus). Accordingly, the focal spots 81S′, 84S′, 81′S′, 82′S′, 83′S′, and 84′S′, which are formed by −1st order diffracted light, consist of light focused substantially on the detection surface 9a. The x-direction focal lines of the focal spots 81″S′, 82S′, 82″S′, 83S′, 83″S′, and 84″S′ are located in front of the detection surface 9a as viewed from the side of the holographic surface 2a, with the y-direction focal lines coinciding with the location of the x-direction focal lines.

The following eight signals are obtained using the detection cells illustrated in FIG. 2A. Here, T1 is a signal obtained in the detection cell 91, T2 is a signal obtained in the detection cell 92, T3 is a signal obtained in the detection cell 93, T4 is a signal obtained in the detection cell 94, F1 is a signal obtained in the focus detection cell 95, F2 is a signal obtained in the focus detection cell 96, S1 is a signal obtained in the tracking detection cell 97, and S2 is a signal obtained in the tracking detection cell 98.

A tracking error signal TE1 relating to the tracks of a wide-pitch optical disc such as a DVD-RAM, etc., a tracking error signal TE2 relating to the tracks of a narrow-pitch optical disc such as a DVD-R, a DVD-RW, etc., a tracking error signal TE3 relating to the tracks of an optical disc used exclusively for playback, such as a DVD-ROM, etc., a focus error signal FE relating to the signal surface of the optical disc, and a playback signal RF relating to the signal surface of the optical disc are obtained from these detection signals based on the following expressions (4) to (8).

TE1=T1+T2−T3−T4 (4)

TE2=S2−S1 (5)

TE3=T1+T3−T2T4 (6)

FE=F1−F2 (7)

RF=T1+T2+T3+T4 (8)

Since the diffracted light components (80a, 80b) produced from the optical disc with a narrow-pitch format such as a DVD-R or a DVD-RW, etc. can be captured in the optical spots 81S, 84S, off-tracking-related intensity variation is produced. This is a phenomenon produced as a result of interference between the so-called zero-order light and diffracted light. On the other hand, since the light spots 81′S, 82′S, 83′S, and 84′S do not contain diffracted light components, no off-tracking-related intensity variation is produced. Moreover, when the objective lens 5 shifts with respect to the optical axis 7 (i.e. the Gaussian center of the laser light) in the process of tracking control, the intensity distribution of the returned light 80 shifts in synchronism therewith. This phenomenon is revealed in the form of the intensity center on the holographic surface 2a moving along the Y-axis, such that, for instance, there is an increase in light quantity at Y>0 and a decrease at Y<0, or an increase in light quantity at Y<0 and a decrease at Y>0. Accordingly, the directions of intensity variation in the optical spot 84S and optical spots 81′S, 82′S become opposite to each other, and the directions of variation in the optical spot 81S and optical spots 83′S, 84′S also become opposite. Consequently, in the signal TE2, off-tracking information can be detected exclusively in a state in which the influence of the objective lens shift is canceled. Namely, in the signal TE2, the influence of the lens shift of the objective lens 5 on off-tracking can be canceled completely by appropriately adjusting the surface area ratio of the three areas formed in each of the quadrants of the holographic surface 2a.

It should be noted that, in an optical disc with a large-pitch format of 1.2 μm or greater, such as a DVD-RAM, etc., the intensity distribution of the returned light 80 is substantially uniform. Consequently, the lens shift-induced intensity variation in each optical spot decreases and the offset of the signal TE1 decreases as well, which makes it suitable for tracking error detection. Furthermore, since no dual-layer disc format has been proposed for DVD-RAM, there is no need to take the influence of the stray light into consideration and there is no disadvantage in tracking error detection based on the signal TE1.

FIG. 3A and FIG. 3B illustrate the appearance of optical spots on the detection surface 9a obtained in the present embodiment at zero defocus of the focused light beam with respect to the signal surface of the optical disc 6, as well as under defocus conditions. FIG. 3A illustrates optical spots in a situation in which the signal surface is closer to the objective lens 5 than under focused conditions, and FIG. 3B illustrates optical spots in a situation in which the signal surface is farther from the objective lens 5 than under focused conditions. Namely, FIG. 3A illustrates optical spots (spots, whose reference numerals have a letter “P” attached thereto) formed by light reflected from the signal surface being used for recording and playback on the optical disc 6 (the signal surface with zero defocus) and optical spots (spots, whose reference numerals have a letter “S” attached thereto) formed by light reflected from another signal surface located closer to the objective lens 5 than said signal surface. Moreover, FIG. 3B illustrates optical spots (spots, whose reference numerals have a letter “P” attached thereto) formed by light reflected from the signal surface being used for recording and playback on the optical disc 6 (the signal surface with zero defocus) and optical spots (spots, whose reference numerals have a letter “S” attached thereto) formed by light reflected from another signal surface located farther from the objective lens 5 than said signal surface. It should be noted that while only the optical spots of the 1st order diffracted light are depicted in FIG. 3A and FIG. 3B, the configuration of the optical spots of the −1st order diffraction light is substantially symmetrical to the optical spots of the 1st order diffracted light about the point of origin 90.

In case of FIG. 3A, none of the optical spots encroaches upon the detection cell 97 and detection cell 98 under defocus conditions. For instance, if the amount of defocus exceeds a certain constant value (one way, δ1), the optical spot that was located at point 84P in the detection cell 97 at zero defocus moves in the “−” direction of the y-axis and produces an optical spot 84S in a location removed from the detection cell 97. The condition related to “δ1” will be described later. Moreover, the optical spot that was located at point 81P in the detection cell 98 moves in the “+” direction of the y-axis and produces an optical spot 81S in a location removed from the detection cell 98. It should be noted that, despite the fact that the optical spots obtained at zero defocus have complicated configurations due to light diffraction as a result of being in the vicinity of the focal point on the detection surface 9a and do not look like shapes overlapping with the sub-areas of the quadrants 21-24 of the holographic surface 2a when light is transmitted through said sub-areas, here, in FIG. 3A, they are displayed as circles.

The reason why these optical spots do not remain in the detection cells 97, 98 is that the optical spots 84S, 81S are formed by diffracted light produced in areas (areas 24b, 21b) displaced from the point of origin 20 in the direction of the Y-axis on the holographic surface 2a; that a portion of the area facing the “−” direction of the y-axis in the detection cell 98 protrudes in the “+” direction of the x-axis in comparison with the area on the “+” side of the y-axis, with the point 81P located in this protruding area; and that the point 84P is located close to the end of the detection cell 97 in the “−” direction of the y-axis.

Moreover, if the amount of defocus exceeds the constant value (one way, δ1), the optical spot that was located at point 81′P in the detection cell 97 at zero defocus moves in the “+” direction of the x-axis and produces an optical spot 81′S in a location removed from the detection cell 98. The optical spot that was located at point 82′P in the detection cell 97 moves in the “−” direction of the x-axis and produces an optical spot 82′S in a location removed from the detection cell 97. The optical spot that was located at point 83′P in the detection cell 98 moves in the “−” direction of the x-axis and produces an optical spot 83′S in a location removed from the detection cell 97. The optical spot that was located at point 84′P in the detection cell 98 moves in the “+” direction of the x-axis and produces an optical spot 84′S in a location removed from the detection cell 98. The reason why they do not remain in the detection cells 97, 98 is that the optical spots 81′S, 82′S, 83′S, and 84′S are formed by diffracted light produced in areas on the holographic surface 2a (areas 21a, 22a, 23a, and 24a) displaced from the point of origin 20 in the direction of the X-axis and that the x-direction width w1/2 of the area in the detection cells 97, 98, in which the optical spots 81′P, 82′P, 83′P, and 84′P are located, is small.

On the other hand, the optical spots that were located in the vicinity of the point 81″P and point 84″P in the detection cell 96 at zero defocus produce, respectively, optical spots 81″S and 84″S expanded in the “+” direction of the x-axis. The optical spots that were located in the vicinity of the point 82P and point 83P in the detection cell 96 produce, respectively, optical spots 82S and 82″S and optical spots 83S and 83″S expanded in the direction of the x-axis. Since the optical spots 84″S, 82S, and 82″S expand away from the detection cells 97, 98, they do not encroach upon the detection cells 97, 98 at any amount of defocus. The optical spots 81″S, 83S, and 83″S expand in the direction of the detection cells 97, 98, but they do not encroach upon the detection cells 97, 98 as long as the amount of defocus does not exceed a constant value (one way, δ2). It should be noted that the condition “δ2” will be described later. The reason why these optical spots (81″S, 82S, 82″, 83S, 83″S, 84″S) do not encroach upon the detection cells 97, 98 is that their starting points (spot locations at zero defocus) are positioned at locations remote from the detection cells 97, 98.

Moreover, in case of FIG. 3B, none of the optical spots encroaches upon the detection cell 97 and detection cell 98 under defocus conditions. For instance, if a certain constant amount of defocus is exceeded (one way, δ1), the optical spot that was located at point 84P in the detection cell 97 at zero defocus moves in the “+” direction of the y-axis and produces an optical spot 84S in a location removed from the detection cell 97. The optical spot that was located at point 81P in the detection cell 98 moves in the “−” direction of the y-axis and produces an optical spot 81S in a location removed from the detection cells 97, 98. The reason why they do not remain in the detection cells 97, 98 is that the optical spots 84S, 81S are formed by diffracted light produced in areas (areas 24b, 21b) displaced from the point of origin 20 in the direction of the Y-axis on the holographic surface 2a; that, in the detection cell 97, a portion of the area on the “−” side of the y-axis protrudes in the “−” direction of the x-axis in comparison with the other area, with the point 84P located in this protruding area; and that the point 81P is located near the end of the detection cell 98 in the “−” direction of the y-axis.

Moreover, if the amount of defocus exceeds the constant value (one way, δ1), the optical spot that was located at point 81′P in the detection cell 97 at zero defocus moves in the “−” direction of the x-axis and produces an optical spot 81′S in a location removed from the detection cell 97. The optical spot that was located at point 82′P in the detection cell 97 moves in the “+” direction of the x-axis and produces an optical spot 82′S in a location removed from the detection cell 98. The optical spot that was located at point 83′P in the detection cell 98 moves in the “+” direction of the x-axis and produces an optical spot 83′S in a location removed from the detection cell 98. The optical spot that was located at point 84′P on the detection cell 98 moves in the “−” direction of the x-axis and produces an optical spot 84′S in a location removed from the detection cell 97. The reason why they do not remain in the detection cells 97, 98 is that the optical spots 81′S, 82′S, 83′S, and 84′S are formed by diffracted light produced in areas on the holographic surface 2a (areas 21a, 22a, 23a, and 24a) displaced from the point of origin 20 in the direction of the X-axis and that the x-direction width w1/2 of the area in the detection cells 97, 98, in which the optical spots 81′P, 82′P, 83′P, and 84′P are located, is small.

On the other hand, the optical spots that were located in the vicinity of the point 81″P and point 84″P in the detection cell 96 at zero defocus produce, respectively, optical spots 81″S and 84″S expanded in the “−” direction of the x-axis. The optical spots that were located in the vicinity of the point 82P and point 83P in the detection cell 96 produce, respectively, optical spots 82S and 82″S and optical spots 83S and 83″S expanded in the “+” direction of the x-axis. Since the optical spots 81″S, 83S, and 83″S expand away from the detection cells 97, 98, they do not encroach upon the detection cells 97, 98 at any amount of defocus. Although the optical spots 84″S, 82S, and 82″S expand in the direction of the detection cells 97 and 98, they do not encroach upon the detection cells 97, 98 as long as the amount of defocus does not exceed a constant value (one way, δ2). The reason why these optical spots (81″S, 82S, 82″, 83S, 83″S, 84″S) do not encroach upon the detection cells 97, 98 is that their starting points (spot locations at zero defocus) are spaced away from the detection cells 97, 98.

In case of a dual-layer disc, light reflecting from the other layer during focusing on one of the layers returns to the detection surface 9a in a state defocused by d/n (one side), or 2d/n (to-and-fro). Dual-layer discs, which have been commercialized as DVD-R or Blu-Ray discs, are optical discs with a two-layer structure, in which an adhesive layer with a thickness of “d” and an index of refraction of “n” is sandwiched between two signal surfaces. The value of “d” provided for in the DVD-R standard is 40 μm<d<70 μm, that provided for in the Blu-Ray standard is 20 μm<d<30 μm, and that provided for in the HD-DVD standard is 17 μm<d<23 μm. As long as the amount of defocus (one side, d/n) is within the range of the following expression (9), light reflected by signal surfaces other than the signal surface to be used for playback in the optical disc 6 does not get into the detection cells 97, 98 as stray light.

δ1<d/n<δ2 (9)

In the above-described embodiment, the expression (9) can easily be satisfied so long as appropriate scaling is used for design. For instance, if n=1.51 and 40 μm<d<70 μm, it is sufficient to scale w1 and w2 such that δ1<26.5 μm and δ2>46.4 μm. Furthermore, if design can be done in such a way that stray light produced at intermediate thickness values (55 μm for DVD-Rs, 25 μm for Blu-Ray discs, and 20 μm for HD-DVDs) is not incident on the detection cells 97, 98 even though the expression (9) is not completely satisfied, it should be possible to handle thicknesses deviating from the central value to a certain extent. In this manner, in the above-described embodiment, light reflected by other signal surfaces located at a distance of d μm behind, or in front of, the signal surface used for playback or recording in the optical disc is not incident on the detection cells 97, 98. Accordingly, tracking control in a dual-layer disc can be made more stable and the off-tracking errors and track jumps during tracking control can be eliminated by utilizing the signal TE2 produced based on the detection signals of the detection cells 97, 98 as a tracking error signal.

Here, explanations will be provided regarding the size requirements for the detection cells 97, 98 that are necessary in order to prevent optical spots from encroaching upon the detection cells 97, 98. As was explained in connection with FIG. 3A and FIG. 3B, when a one-way δ1 defocus occurs, the optical spot that was at point 81P of the detection cell 98 at zero defocus produces an optical spot 81S as a result of moving in the “−” direction or “+” direction of the y-axis. In the same way, as was explained in connection with FIG. 3A and FIG. 3B, when a one-way δ1 defocus occurs, the optical spot that was at point 84P of the detection cell 98 at zero defocus produces an optical spot 84S as a result of moving in the “−” direction or “+” direction of the y-axis. The following conditions have to be met in order to prevent these optical spots 81S and 84S from encroaching upon the detection cells 97, 98.

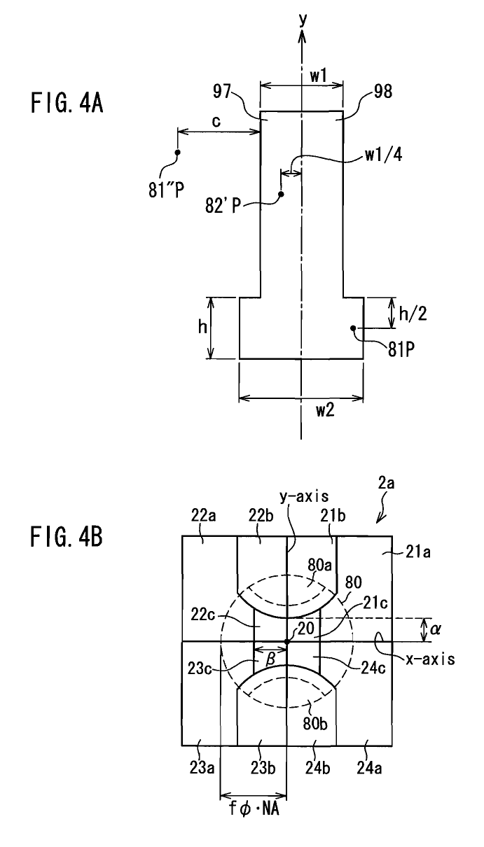

Namely, as illustrated in FIG. 4A, the optical spots 81P and 84P obtained at zero defocus preferably are located at a distance of h/2 from the end of the detection cells 97 and 98 in the “−” direction of the y-axis, wherein “h” is the length in the direction of the y-axis of the widened area of the detection cells 97, 98. Moreover, these optical spots 81P and 84P are positioned at locations spaced away by a distance of w1/2 from the y-axis in the widened area of the detection cells 97 and 98.

The diameter D1 of a full-aperture spot formed on the detection surface 9a when the one-way defocus amount is δ1 is obtained from the following expression (10). It should be noted that NA is the numerical aperture of the objective lens 5, “fc” is the focal length of the collimating lens 4, and “fφ” is the focal length of the objective lens 5. In addition, it is assumed that δ1=d1/n. “d1” is the minimum interlayer thickness of the dual-layer disc, which is, for instance, not more than 40 μm in the case of a DVD-R or a DVD-RW. The index of refraction of the disc substrate of the optical disc 6 is designated as “n”.

D1=2×fφ×NA×2×δ1/fc×(fc/fφ)²=fc/fφ×4×NA×d1/n (10)

Now, the condition required to prevent the above-described optical spots 81P and 84P from encroaching upon the detection cells 97, 98 when the one-way defocus amount is δ1 is that the following expression (11) be satisfied. It should be noted that, as illustrated in FIG. 4B, α is the distance along the y-axis from the point of origin 20 to the boundary between the area 21c and area 21b on the holographic surface 2a.

h/2<D1×α(fφ×NA) (11)

The condition of the expression above (11) can be expressed in the following manner (12).

h/α<4×fc/fφ²×d1/n (12)

The optical spots 81P and 84P obtained at zero defocus when the condition of this expression (12) is satisfied are located at a distance greater than w1/2 from the y-axis in the area of the detection cells 97, 98 that is widened in the direction of the x-axis, as a result of which the optical spots 81S and 84S do not encroach upon the detection cells 97, 98 when the amount of one-way defocus exceeds δ1.

Furthermore, as was explained with reference to FIG. 3A, the optical spot 81″P illustrated in FIG. 4A produces an optical spot 81″S enlarged in the “+” direction of the x-axis when the signal surface approaches the objective lens 5. The condition required to prevent this optical spot 81″S from encroaching upon the detection cell 97 when the one-way defocus amount is δ2 is that the following expression (13) be satisfied. It should be noted that, as illustrated in FIG. 4A, “c” is the distance from the optical spot 81″P to the detection cell 97 along the x-axis. In addition, it is assumed that δ2=d2/n. “d2” is the maximum interlayer thickness of the dual-layer disc, which is, for instance, not more than 70 μm in case of a DVD-R or a DVD-RW. “D2” is the diameter of a full-aperture spot formed on the detection surface 9a when the one-way defocus amount is δ2.

c>D2=fc/fφ×4×NA×d2/n (13)

In the same manner, when this condition is met, the optical spot 84″S, which is generated from the optical spot 84″P illustrated in FIG. 3B when the one-way defocus amount is δ2, does not interfere with the detector 98.

Furthermore, as was explained in connection with FIG. 3B, the optical spot 82′P illustrated in FIG. 4A produces an optical spot 82′S shifted in the “+” direction of the x-axis when the signal surface moves away from the objective lens 5. The condition required to prevent this optical spot 82′S from encroaching upon the detection cell 98 when the one-way defocus amount is δ1 is that the following expression (14) be satisfied. It should be noted that, as illustrated in FIG. 4B, β is the distance along the x-axis from the point of origin 20 to the boundary between the area 21c and area 21a on the holographic surface 2a.

¾×w1<D1×β/(fφ×NA) (14)

The condition of the expression (14) above can be expressed in the following manner (15).

w/β<16/3×fc/fφ²×d1/n (15)

It should be noted that, in the above-described embodiment, the detection cells 97, 98 are employed as photodetecting cells used for tracking error signals, with the holographic surface 2a configured such that the optical spots 84S, 81′S, and 82′S are arranged in the detection cell 97 and optical spots 81S, 83′S, and 84′S are arranged in the detection cell 98. This, however, is merely an example, and various embodiments are possible in terms of the combinations, in which these optical spots can be arranged in the detection cells 97, 98.

Moreover, while the explanations provided in the embodiment described above referred to a situation in which the optical disc 6 was a dual-layer disc, the same applies to, and the same effects will be obtained, in case of 4-layer, 8-layer, and other multi-layer discs.

Moreover, although in the embodiment described above the light source 1 and detector surface 9a were formed on the same substrate, it is equally possible to form them separately and, furthermore, provide two collimating lenses for separate forward and return use without any variation in the resultant effects.

Furthermore, the embodiment described above is characterized in that only optical spots produced from the areas 21a-24a or areas 21b-24b, which are spaced away from the point of origin 20 on the holographic surface 2a, are collected in the tracking detection cells. Other embodiments, as long as they have the same features, can produce the same effects.

For instance, in the embodiment described above the tracking detection cells 97, 98 were arranged in the vicinity of the point of origin along the x-axis and the focus detection cells 95, 96 were arranged on the “+” and “−” side of the x-axis relative to the tracking detection cells 97, 98. However, other configurations, in which the opposite is contemplated, may be used as well, such as arranging the detection cells 95, 96 used for focus error signal detection in the vicinity of the point of origin of the x-axis, arranging the detection cell 97 used for tracking error signal detection on the “+” side of the x-axis, and arranging the detection cell 98 on the “−” side of the x-axis.

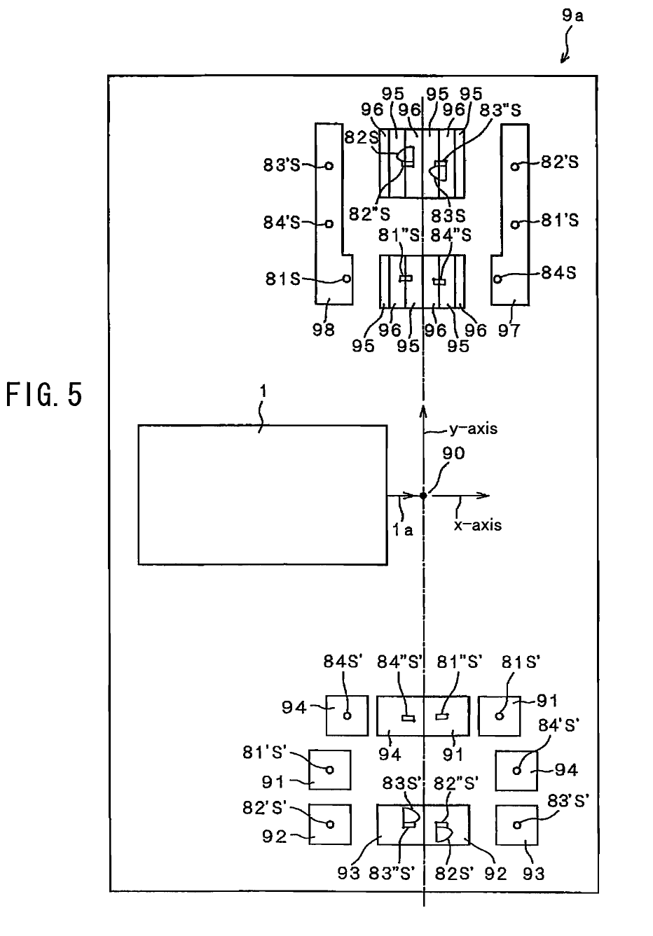

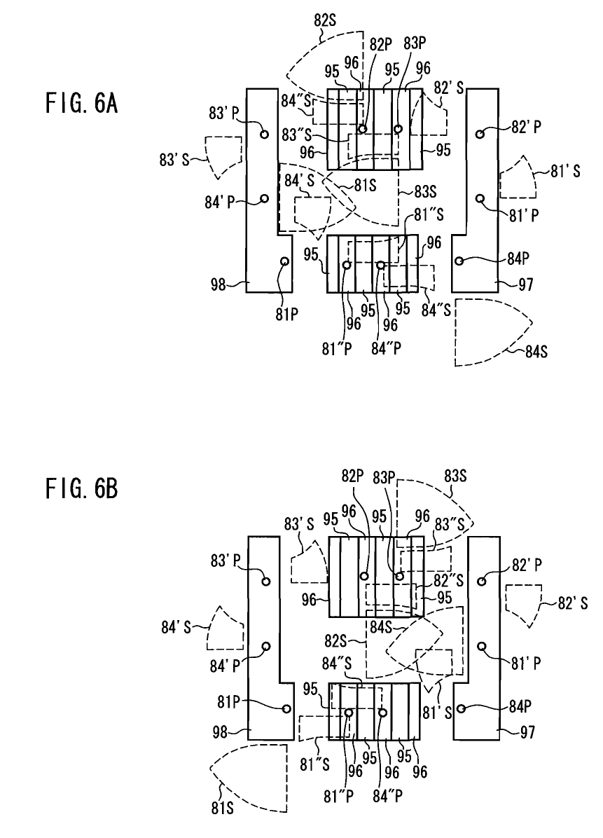

An exemplary configuration obtained in this case is illustrated in FIG. 5 as another embodiment of the present invention. FIG. 5 is identical to FIG. 2 in every manner except in terms of the position of the detection cells and optical spots, which is why detailed explanations are omitted. Furthermore, FIG. 6A and FIG. 6B illustrate the appearance of optical spots on the detection surface 9a obtained based on the detection cell arrangement illustrated in FIG. 5 at zero defocus of the focused light beam with respect to the signal surface of the optical disc 6, as well as under defocus conditions. FIG. 6A illustrates optical spots in a situation in which the signal surface is closer to the objective lens 5 than under focused conditions, and FIG. 6B illustrates optical spots in a situation in which the signal surface is farther from the objective lens 5 than under focused conditions. Namely, FIG. 6A illustrates optical spots (spots, whose reference numerals have a letter “P” attached thereto) formed by light reflected from the signal surface being used for recording and playback on the optical disc 6 (the signal surface with zero defocus) and optical spots (spots, whose reference numerals have a letter “S” attached thereto) formed by light reflected from another signal surface located closer to the objective lens 5 than said signal surface. Moreover, FIG. 6B illustrates optical spots (spots, whose reference numerals have a letter “P” attached thereto) formed by light reflected from the signal surface being used for recording and playback on the optical disc 6 (the signal surface with zero defocus) and optical spots (spots, whose reference numerals have a letter “S” attached thereto) formed by light reflected from another signal surface located farther from the objective lens 5 than said signal surface. It should be noted that while only the optical spots of the 1st order diffracted light are depicted in FIG. 6A and FIG. 6B, the configuration of the optical spots of the −1st order diffraction light is substantially symmetrical to the optical spots of the 1st order diffracted light about the point of origin 90.

If the detection cell arrangement illustrated in FIG. 5 is used, then, as illustrated in FIG. 6A and FIG. 6B, exceeding a certain constant amount of defocus causes the optical spots located in the tracking detection cell 97 and tracking detection cell 98 to move away and, as long as the amount of defocus does not exceed a certain constant value, the optical spots located in the focus detection cells 95, 96 do not encroach upon the tracking detection cells 97, 98. Therefore, the detection cell arrangement illustrated in FIG. 5 produces effects completely identical to those of the detection cell arrangement illustrated in FIG. 2.

Furthermore, the division of the holographic surface 2a into sub-areas is not limited to the embodiment illustrated in FIG. 2B. For instance, the shape of the areas 21c-24c adjacent to the point of origin 20 is not limited to the configuration illustrated in FIG. 2B and can be any arbitrary shape as long as the areas are in contact with the point of origin 20.

### INDUSTRIAL APPLICABILITY

Since only the optical spots produced from areas remote from the point of origin on the holographic surface are collected on the tracking detector, the optical disc device according to the present invention can provide stable tracking control, and, as a result, is useful as a device that handles various optical discs and can enhance the accuracy of recording and playback of multi-layer discs.

1. An optical disc device comprising a light source, an optical splitter element, an objective lens, and a photodetector,
wherein the objective lens, along with focusing light emitted from the light source onto a signal surface of an optical disc, allows light reflected by the signal surface to be incident on the photodetector;
the optical splitter element has first areas comprising the location of the optical axis of the light incident from the objective lens and, around the periphery of the first areas, second areas positioned at locations displaced from the optical axis, separates light incident on the first areas from light incident on the second areas and allows it to be incident on the photodetector;
the detection surface of the photodetector has first detection areas used for detecting light incident from the first areas of the optical splitter element and second detection areas provided at locations displaced from the first detection areas and used for detecting light incident from the second areas of the optical splitter element, with signals detected in the second detection areas used for detecting tracking error signals of the optical disc; and,
when the optical disc has a plurality of signal surfaces, the portion of the light reflected by signal surfaces other than the signal surface being used for focusing by the objective lens that is composed of light incident on the photodetector from the first areas of the optical splitter element is not incident on the second detection areas.

2. The optical disc device according to claim 1,
wherein the photodetector detects focus error signals of the optical disc using signals detected in the first detection areas.

3. The optical disc device according to claim 1,
wherein the optical splitter element is formed such that the portion of the light reflected by other signal surfaces that is composed of light incident on the photodetector from the first areas of the optical splitter element is not incident on the second detection areas when “d”, which represents the distance between the signal surface of the optical disc used for focusing by the objective lens and another signal surface, is in the range of from 40 μm to 70 μm.

4. The optical disc device according to claim 3,
wherein the optical splitter element is formed such that the portion of the light reflected by other signal surfaces that is composed of light incident on the photodetector from the first areas of the optical splitter element is not incident on the second detection areas when the “d” is 55 μm.

5. The optical disc device according to claim 1,
wherein the optical splitter element is formed such that the portion of the light reflected by other signal surfaces that is composed of light incident on the photodetector from the first areas of the optical splitter element is not incident on the second detection areas when “d”, which represents the distance between the signal surface of the optical disc used for focusing by the objective lens and another signal surface, is in the range of from 20 μm to 30 μm.

6. The optical disc device according to claim 5,
wherein the optical splitter element is formed such that the portion of the light reflected by other signal surfaces that is composed of light incident on the photodetector from the first areas of the optical splitter element is not incident on the second detection areas when the “d” is 25 μm.

7. The optical disc device according to claim 1,
wherein the optical splitter element is formed such that the portion of the light reflected by other signal surfaces that is composed of light incident on the photodetector from the first areas of the optical splitter element is not incident on the second detection areas when “d”, which represents the distance between the signal surface of the optical disc used for focusing by the objective lens and another signal surface, is in the range of from 17 μm to 23 μm.

8. The optical disc device according to claim 7,
wherein the optical splitter element is formed such that the portion of the light reflected by other signal surfaces that is composed of light incident on the photodetector from the first areas of the optical splitter element is not incident on the second detection areas when the “d” is 20 μm.

9. The optical disc device according to claim 1,
wherein the location of the optical axis of light incident on the surface of the photodetector without being split by the optical splitter element is used as the point of origin, a straight line that passes through the point of origin and is parallel to a radial direction of the optical disc is used as a y-axis, and a straight line that passes through the point of origin and intersects with the y-axis at right angles is used as an x-axis, the second detection areas in the photodetector are formed parallel to the y-axis and the first detection areas are formed such that they are split in two in the direction of the x-axis so as to sandwich the second detection areas.

10. The optical disc device according to claim 1,
wherein the location of the optical axis of light incident on the surface of the photodetector without being split by the optical splitter element is used as the point of origin, a straight line that passes through the point of origin and is parallel to a radial direction of the optical disc is used as a y-axis, and a straight line that passes through the point of origin and intersects with the y-axis at right angles is used as an x-axis, the first detection areas in the photodetector are formed parallel to the y-axis and the second detection areas are formed such that they are divided in two in the direction of the x-axis so as to sandwich the first detection areas.

11. The optical disc device according to claim 1,
wherein the second detection areas have a first portion, whose length in the direction of the x-axis is relatively smaller, and a second portion, whose length is relatively larger.

12. The optical disc device according to claim 11,
wherein, among the optical spots formed in the second detection areas at zero defocus with respect to the signal surface of the optical disc, those optical spots that are located in the second portion are formed in the second portion, substantially in the center in the direction of the y-axis, at locations spaced away by w1/2 from the y-axis, where w1 is the length of the first portion in the direction of the x-axis in the second detection areas and w2 is the length of the second portion in the direction of the x-axis.
